(19) United States
(12) Patent Application Publication
(10) Pub. No.: US 2009/0046553 A1
(43) Pub. Date: Feb. 19, 2009

(54) Protection of disk data carriers against making illegal copies

(76) Inventor: Zdenek Varga, Praha 10-Dubec (CZ)

Correspondence Address: Peter R. Ruzek, 24 Green Woods Lane, Farmington, CT, 06085, US

(21) Appl. No.: 11/919,780

(22) PCT Filed: Mar. 30, 2006
(86) PCT No.: PCT/CZ2006/000015

§ 371 Date: Oct. 30, 2007

(30) Foreign Application Priority Data
Mar. 30, 2005 (CZ) PUV 2005-16442
Mar. 30, 2005 (CZ) PV 2005-197

(51) Int. Cl. G11B 19/04

(52) U.S. Cl. 369/53.21; G9B/19.005

(57) ABSTRACT

Present invention refers to a system for protection of data storage discs such as CD, DVD, Video CD, Photo CD, etc., containing subjects of copyright, from illegal copying. Present invention comprises a disc with security code, modified reading device and software. The disc is equipped with a security code situated outside the disc centre, which completely fills and utilizes this area. The software checks and verifies the presence of the security code read by the modified reading device.

### FIELD OF INVENTION

Present invention refers to protection of data storage discs such as CD, DVD, Video CD, Photo CD, etc., containing subjects of copyright, from illegal copying. Present invention comprises a disc with security code, modified reading device and software.

### BACKGROUND ART

A method called Safe Disc is known for this protection. It is based on verification of digital signature loaded on the disc in multilevel encrypted “coverage”, which protects the content of the CD-ROM. Digital signature is incorporated by laser while master or original disc is being produced, and usually cannot be copied by CD burner or compacting machine. When the original disc is inserted to the drive, the verifying software reads digital signature allowing next decoding of inserted program and its start. If a non-authorized CD without signature is inserted, the program does not start.

Another known method of data storage disc protection, described in U.S. Pat. No. 5,696,757, is based on specific characteristics of data records on disc, where shapes of pits are traced and evaluated. The protection is made by controlling of pits' position with respect to the track axis. Present ways of users' copy discs creation allow only making copies on which the shape of pits and their position relative to the track axis is only similar, in acceptable tolerance. The technology of industrial production of discs allows more accuracy in both shape and position of pits. So if reader with ability of recognizing the position of pits is used, it can easily find out whether the inserted disc is original or it is a copy made by users' means—burners. In the same time, for increasing of the security, some of the pits are duly written in the track axis and others are duly written off centered in the defined way. This method reliably recognizes industrially produced discs from copies made by users.

The purpose of present technical solution is to exclude the possibility of illegal copying of discs containing copyright material.

### DISCLOSURE OF INVENTION

Said purpose is reached by data discs protection according to present technical solution, comprising a disc with security code, reading device and software. The subject-matter of this technical solution is as follows:
the security code is written on a disc in the security code field placed around the centre of the disc next to the data field,
the reading device is equipped with additional laser head for security code reading, integrated into the laser head for data field reading,
the software contains steps of security code verification and evaluation of algorithmic link between actually read data and actually read security code.

The security code field is set out in an annulus concentric to the disc centre, with diameters from 17 to 23 mm.

The software checks the presence of security code, and/or files the values of the code, and/or checks the mutual location of set item of the code and actually read item in data field, and/or controls mutual logical link between set item of the code and actually read item in data field according to a defined cryptography algorithm, and/or uses security code as a decoder to decode entries in data field according to a defined cryptography algorithm.

The data storage disc is equipped with a security code situated outside the disc centre, which completely fills and utilizes the whole inner part capacity for disc record in the area outside of the disc centre in front of the data area. This solution allows the protection from copying onto recordable media because of the lack of space for data entering in this space, where it is not possible to completely record the data because of the lack of data space. When utilizing solution according to present invention, where the data fully fill the area situated outside the disc centre in front of the data field dedicated to the security code record, then the security code cannot be copied onto recordable media.

The pressed (original) CDs, DVDs have different physical characteristics than the burned CDs, DVDs. Because of that it is possible to get such high record density, which cannot be applied by burning.

Thus, if the central area, where the code is situated, is fully equipped with data serving to the security of the data field, it is impossible to being copied.

The exact orientation of the coding field in the area situated outside the disc centre in front of the data field, and its mutual position to the data field is used to fortification of the security code. This can be set up only during the original production.

### DISCLOSURE OF FIGURES

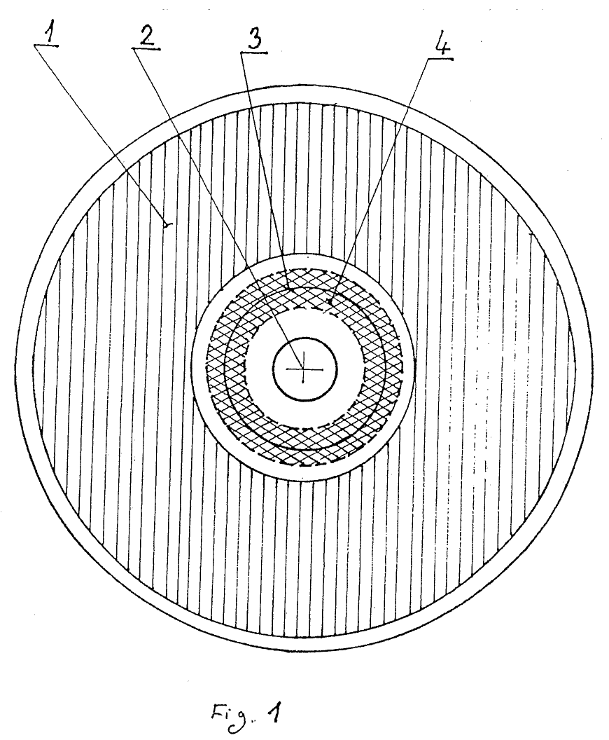

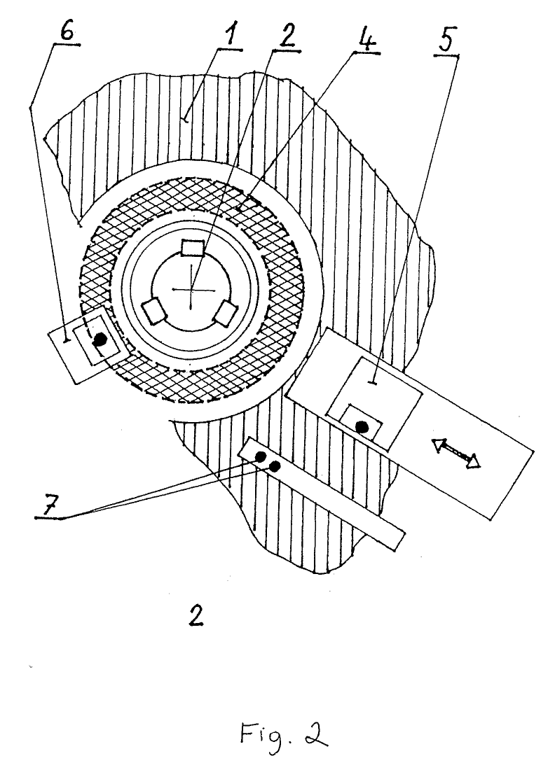

Technical solution is disclosed on drawings, where FIG. 1 schematically represents data storage disc and FIG. 2 schematically represents the reading device.

### EXAMPLES OF THE TECHNICAL SOLUTION CONCEPTS

### Example Nr. 1

Data storage disc on FIG. 1 is equipped with security code 3, written in security code 3 field 4, located 20 mm from the disc centre 2 outside the data field 1. The security code 3 entry is of similar character as data entered in the data field 1. This means that the security code 3 is created by pits and lands of the same characteristics as the data entry in data field 1, therefore is readable by standard type of reading device—laser, that is used for data reading in present disc drives. Security code 3 has its own TOC (table of contents), which defines the distribution of data in security code 3. It is possible to use data capacity of about 1 MB, according to the laser used in reading device, for the security code entry, which is amount sufficient for use in cryptographic data coding or verifying procedures.

Reading device on FIG. 2 contains laser head 5 for reading in data field 1 and additional laser head 6 for security code 3 reading, located in security code 3 field 4. This additional laser head 6 is of standard type used in present disc drives. The reading device is further equipped with components 7 for setting the laser head 5 on data field 1 reading and writing and for setting the additional laser head 6 on security code 3 reading.

### Function:

Data in data field 1 are encrypted by security code 3, which is used as the key for cryptographic data coding. Actual data in data field 1 in this status are readable but don't make any sense without the key and thus are useless without the security code 3. When copy of this disc is made by present disc copy devices, only the copy of data field 1 is made. The copy then cannot be used.

Disc contains security code 3 with figures:

Security
code

| | | | | |
|---|---|---|---|---|
| 1 | 0 | 3 | 6 | 2 |

Data entry on the disc contains data in data field 1 with figures:

Entry in data field

| | | | | | | | | | | | | | | |
|---|---|---|---|---|---|---|---|---|---|---|---|---|---|---|
| 3 | 6 | 1 | 0 | 0 | 2 | 5 | 1 | 1 | 2 | 4 | 1 | 5 | −3 | 3 |

Required record, executable file or displayable picture, eventually a sound record is achieved by conversion according to algorithm. In this example, it is a simple algorithm of plain summation of values:

Decoding of record

| | | | | | | | | | | | | | | |
|---|---|---|---|---|---|---|---|---|---|---|---|---|---|---|
| 3 | 6 | 1 | 0 | 0 | 2 | 5 | 1 | 1 | 2 | 4 | 1 | 5 | −3 | 3 |
| 1 | 0 | 3 | 6 | 2 | 1 | 0 | 3 | 6 | 2 | 1 | 0 | 3 | 6 | 2 |
| 4 | 6 | 4 | 6 | 2 | 3 | 5 | 4 | 7 | 4 | 5 | 1 | 8 | 3 | 5 |

### Line 1

Contains record as it is written in data field 1 of the disc.

### Line 2

Contains repeated security code 3.

### Line 3

In this last line of the table there is the record decoded into the required usable format.

### Example Nr. 2

For example, installation disc of a hypothetic program “APPLICATION” is used, which is probably going to be used by the user just once, for the installation, and after that, he won't be asked to prove his right to use this program by repeated inserting of the disc into the reading device.

The procedure is going to be as follows:
1) The installation program is released
2) Installation program automatically asks for the presence of security code with required values
2a) The presence of security code was not confirmed (and/or) the security code does not show the required values

The installation program ends with error message
2b) The presence of security code was confirmed and the values are as required

The installation program runs the installation of “APPLICATION”
3) The installation program reaches the defined point of 50% of the installation
4) Automatic request of the installation program for the presence of security code with required values
4a) The presence of security code was not confirmed (and/or) the security code does not show the required values

The installation program ends with error message and uninstalls just installed files of “APPLICATION”
4b) The presence of security code was confirmed and the values are as required

The installation program continues with the installation of “APPLICATION”
5) The installation of “APPLICATION” is finished.

### Example Nr. 3

Suitable example of using the protection of disc data storage according to present technical solution is its application in playing consoles. Disc data storage is equipped with security code 3 in the same way as in example nr. 1, with difference of the security code containing also TOC for data field 1. Data field 1 does not contain TOC.

### Example Nr. 4

Suitable example of using the protection of disc data storage according to present technical solution is the application in which the disc data storage is equipped with security code 3, which completely fills and utilizes the whole capacity of the inner area of the record on the disc in the security code area 4 situated outside the disc centre 2 in front of the data field 1

### INDUSTRIAL UTILIZATION

The protection of data storage disc from illegal copying according to present technical solution is utilizable namely in playing consoles.

1. The protection of data storage discs from illegal copying comprising storage disk with security code, reading device and software, characterized by digital security code (3) being written on the disc in security code field (4) situated around the disc centre (2) next to data field (1), reading device being equipped by additional laser head (6) for security code (3) reading, integrated into the laser head (5) for data field (1) reading.

2. The protection of data storage discs according to claim 1, characterized by security code field (2) being delimited by annulus concentric with disc centre (2) with diameters from 17 to 23 mm.

3. The protection of data storage discs according to claim 1, characterized by the storage disc being equipped with the security code (3), which completely fills and utilizes the entire capacity of the inner part for the disc record in the security code area (4) situated outside the disc centre (2) in front f the data field (1).

4. The protection of data storage discs according to claim 1, characterized by the current reading head (5) being able to read data in the area situated outside the disc centre (2) in front of the data field (1) in the security code area (4).

5. The protection of data storage discs according to claim 1, characterized by the orientation of the coding field, and the mutual position with the data field being used for the fortification of the security record.
